(19) United States
(12) Patent Application Publication
(10) Pub. No.: US 2026/0009919 A1
(43) Pub. Date: Jan. 8, 2026

(54) METHODS AND COMPUTING SYSTEMS FOR PREDICTING SURFACE RELATED MULTIPLES IN SEISMIC DATA

(71) Applicant: Schlumberger Technology Corporation, Sugar Land, TX (US)

(72) Inventors: Zhimei YAN, Houston, TX (US); Scott SLATON, Houston, TX (US); Massimiliano VASSALLO, Crawley (GB)

(21) Appl. No.: 19/127,766

(22) PCT Filed: Mar. 15, 2024
(86) PCT No.: PCT/US2024/020117

§ 371 Date: May 7, 2025

Related U.S. Application Data
(60) Provisional application No. 63/490,540, filed on Mar. 16, 2023.

(51) Int. Cl. G01V 1/30

(52) U.S. Cl. CPC G01V 1/307; G01V 2210/42; G01V 2210/63

(57) ABSTRACT

A method includes receiving a seismic data volume including target traces. The method also includes sparse sampling the target traces to produce a subset of representative target traces. The method also includes generating a broad area map for each representative target trace. The area map includes multiple downward reflection points (DRPs) laid out as a grid and multiple blocks. The method also includes convolving a seismic trace pair for each DRP to produce a convolved trace. The method also includes calculating a contribution weight based on a root mean square (RMS) and a semblance attribute for each block at each time window. The method also includes summing the contribution weight for each block. The method also includes selecting a set of blocks that have summed contribution weight above a threshold value. The method also includes determining one or more apertures that encompass the set of blocks.

### CROSS-REFERENCE TO RELATED APPLICATIONS

This application claims priority to U.S. Provisional Patent Application No. 63/490,540, filed on Mar. 16, 2023, which is incorporated by reference herein.

### BACKGROUND

Seismic surveying generally includes the process of recording reflected seismic waves from beneath the subsurface in order to model geological structures and physical properties of the earth. For instance, the aim of a seismic survey may be to depict the physical properties of a reservoir. Many techniques have been used or proposed for processing the collected survey data, yet the processing of such data to form reliable and accurate images of the subsurface is often difficult.

Accordingly, there is a need for methods and computing systems that can employ more effective and accurate methods for identifying, isolating, transforming, and/or processing various aspects of seismic signals or other data that is collected from a subsurface region or other multi-dimensional space.

As those with skill in the art will appreciate, processing techniques for seismic data may be successfully applied to other types of collected data in varying circumstances.

### SUMMARY

The computing systems, methods, processing procedures, techniques and workflows disclosed herein are more efficient and/or effective methods for identifying, isolating, transforming, and/or processing various aspects of seismic signals or other data that is collected from a subsurface region or other multi-dimensional space.

In some embodiments, a method for determining optimized parameters for seismic data processing is presented. The method includes receiving a seismic data volume comprising target traces; sparse sampling the seismic data volume target traces to produce a subset of representative target traces; generating a broad area map for each representative target trace, the area map comprising multiple downward reflection points (DRPs) laid out as a grid and multiple blocks and each block makes up a portion of the broad area map; convolving a seismic trace pair for each DRP to produce a convolved trace that includes more than one convolved sample value; assigning the convolved trace into one of the blocks; dividing the convolved trace into a plurality of time windows; and calculating a root mean square (RMS) for the stack trace of all the convolved traces and a semblance attribute of each time window in each block. The semblance attribute is given by

$$\frac{{\sum }_{i = 1}^{N} {( {\sum }_{j = 1}^{M} {d}_{ij} )}^{2}}{M {\sum }_{i = 1}^{N} {\sum }_{j = 1}^{M} {d}_{ij}^{2}}$$

(wherein dᵢⱼ is the sample value at time tᵢ and location xⱼ of the convolved trace, M is the number of convolved traces within the block, and N is a total number of time samples within the time window), the square root of numerator divided by N in the equation is the RMS of the stack trace. The method continues with the RMS and semblance attribute values being used in calculating or estimating a contribution weight based upon the RMS and semblance attribute values for each block at each time window; summing the contribution weight of all the time windows for each block; selecting a set of the blocks that have a summed contribution weight above a threshold value: determining one or more apertures that encompass the set of blocks, wherein the determined apertures are asymmetric relative to a mid-point between the source and the receiver and determining a spacing of the DRPs by alias energy detection of decimation stacking of the convolved traces within the determined apertures.

The method may also include performing seismic processing on the seismic data volume using the determined apertures and the determined DRP spacing. The seismic processing may include data driven three-dimensional surface related multiple elimination (3D SRME) seismic processing. The method may also include generating a migrated image based upon a result of the seismic processing and performing an action based upon the migrated image, wherein the action comprises selecting where to drill a wellbore, determining or varying a trajectory of the wellbore, or a combination thereof. Further, the method may include displaying the migrated image to a user.

The apertures of the method may include a source aperture, a receiver aperture, a left crossline aperture and a right crossline aperture. Each representative target trace may include a source, a source location, a receiver and a receiver location, and further wherein the area map is referenced to the source and receiver locations. Each of the multiple blocks may overlap with one or more adjacent blocks.

The method may also include interpolating the determined apertures and the determined DRP spacing from the subset of the representative target traces onto the seismic data volume.

In another embodiment, a computing system is provided for determining optimized parameters for seismic data processing, the computing system comprises one or more processors; and a memory system comprising one or more non-transitory computer-readable media storing instructions. The instructions, when executed by at least one of the one or more processors, cause the computing system to perform operations including receiving a seismic data volume comprising target traces; sparse sampling the seismic data volume target traces to produce a subset of representative target traces; generating a broad area map for each representative target trace, the area map comprising multiple downward reflection points (DRPs) laid out as a grid and multiple blocks, each block makes up a portion of the broad area map; convolving a seismic trace pair for each DRP to produce a convolved trace that includes more than one convolved sample value; assigning the convolved trace into one of the blocks; dividing the convolved trace into a plurality of time windows; calculating a root mean square (RMS) for the stack trace of all the convolved traces and a semblance attribute of each block at each time window. The semblance attribute is given by

$$\frac{{\sum }_{i = 1}^{N} {( {\sum }_{j = 1}^{M} {d}_{ij} )}^{2}}{M {\sum }_{i = 1}^{N} {\sum }_{j = 1}^{M} {d}_{ij}^{2}} ,$$

wherein dᵢⱼ is the sample value at time tᵢ and location xⱼ of the convolved trace, M is the number of convolved traces within the block, and N is a total number of time samples within the time window, the square root of the numerator divided by N in the equation is the RMS of the stack trace. The method continues with estimating a contribution weight for each block and each time window, the contribution weight may be calculated based upon the RMS and semblance attribute values; summing the contribution weights of all the time windows for each block; selecting a set of the blocks that have a summed contribution weight above a threshold value; determining one or more apertures that encompass the set of blocks, the determined apertures are asymmetric relative to a mid-point between the source and the receiver; and determining a spacing of the DRPs by alias energy detection of decimation stacking of the convolved traces within the determined apertures.

The computing system operations may also include performing seismic processing on the seismic data volume using the determined apertures and the determined DRP spacing. The seismic processing may include data driven three-dimensional surface related multiple elimination (3D SRME) seismic processing.

The computing system operations may also include generating a migrated image based upon a result of the seismic processing and performing an action based upon the migrated image. The action may involve selecting where to drill a wellbore, determining or varying a trajectory of the wellbore, or a combination thereof. The operations may also include displaying the migrated image to a user. The operations may also include interpolating the determined apertures and the determined DRP spacing from the subset of the representative target traces onto the seismic data volume.

The apertures of the computing system operations may comprise a source aperture, a receiver aperture, a left crossline aperture and a right crossline aperture. Each representative target trace may include a source, a source location, a receiver and a receiver location, and further wherein the area map is referenced to the source and receiver location. Each of the multiple blocks may overlap with one or more adjacent blocks.

In another embodiment, a non-transitory computer-readable medium stores instructions that, when executed by one or more processors of a computing system, cause the computing system to perform operations for determining optimized parameters for seismic data processing. The operations include receiving seismic volume data that includes target traces; sparse sampling the target traces to produce a subset of representative target traces; generating a broad area map for each representative target trace, the area map comprising multiple downward reflection points (DRPs) laid out as a grid and multiple blocks, each block makes up a portion of the broad area map and the broad area is referenced to the source and receiver location; convolving a seismic trace pair for each DRP to produce a convolved trace, wherein the seismic trace pair comprises more than one seismic sample value, the convolved trace comprises more than one convolved sample value; assigning the convolved trace for a given target trace into one of the blocks; dividing the convolved trace into a plurality of time windows; calculating a root mean square (RMS) and a semblance attribute of the convolved traces for each block at each time window. The semblance attribute is given by

$$\frac{{\sum }_{i = 1}^{N} {( {\sum }_{j = 1}^{M} {d}_{ij} )}^{2}}{M {\sum }_{i = 1}^{N} {\sum }_{j = 1}^{M} {d}_{ij}^{2}}$$

wherein dᵢⱼ is the sample value at time tᵢ and location xⱼ of the convolved traces, M is the number of convolved traces within the block, and N is a total number of time samples within the time window. The method continues with estimating a contribution weight for each block and each time window, the contribution weight is calculated based upon the RMS and semblance attribute values; summing the contribution weights of all the time windows for each block; selecting a set of the blocks that have a summed contribution weight above a threshold value; determining a source aperture, a receiver aperture, a left crossline aperture and a right crossline aperture that encompass the set of blocks, wherein the determined apertures are asymmetric relative to a mid-point between the source location and the receiver location; determining a spacing of the DRPs by alias energy detection of decimation stacking of the convolved traces within the determined apertures; interpolating the determined apertures and the determined DRP spacing from the subset of the representative target traces onto the seismic volume data; performing seismic processing on the seismic volume data using the determined apertures and the determined DRP spacing, the seismic processing comprises data driven three-dimensional surface related multiple elimination (3D SRME) seismic processing; and performing an action based upon a result of the 3D SRME seismic processing, the action may include selecting where to drill a wellbore, determining or varying a trajectory of the wellbore, or a combination thereof.

The non-transitory computer-readable medium instructions may also include generating a migrated image based upon a result of the 3D SRME and displaying the migrated image to a user. The multiple blocks of the non-transitory computer-readable medium instructions may overlap with one or more adjacent blocks. Further, each target trace includes a source, a source location, a receiver and a receiver location.

These systems, methods, processing procedures, techniques, and workflows increase effectiveness and efficiency. Such systems, methods, processing procedures, techniques, and workflows may complement or replace conventional methods for identifying, isolating, transforming, and/or processing various aspects of seismic signals or other data that is collected from a subsurface region or other multi-dimensional space.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 depicts an example computing system, in accordance with some embodiments.

FIG. 2 illustrates a survey operation being performed by a survey tool, such as a seismic truck, to measure properties of the subterranean formation, in accordance with some embodiments.

FIG. 3 illustrates a drilling operation being performed by drilling tools suspended by rig and advanced into subterranean formations to form wellbore, in accordance with some embodiments.

FIG. 4 illustrates a wireline operation being performed by a wireline tool suspended by the rig and into the wellbore of FIG. 3, in accordance with some embodiments.

FIG. 5 illustrates a production operation being performed by a production tool deployed from a production unit or a Christmas tree and into the completed wellbore for drawing fluid from the downhole reservoirs into surface facilities, in accordance with some embodiments.

FIG. 6 illustrates a schematic view, partially in cross section, of an oilfield having data acquisition tools positioned at various locations along the oilfield for collecting data of the subterranean formation, in accordance with some embodiments.

FIG. 7 illustrates an oilfield for performing production operations, in accordance with some embodiments.

FIG. 8 illustrates a side view of a marine-based survey of a subterranean subsurface, in accordance with some embodiments.

FIG. 9 illustrates a marine electromagnetic survey system, in accordance with some embodiments.

FIG. 10 illustrates a marine survey system according to some embodiments.

FIG. 11 illustrates the map view of 3D construction of surface multiple model trace for a target trace with source at S and receiver at R.

FIG. 12 illustrates two types of features in an MCG, an apex area and a dipping area.

FIG. 13 illustrates a DRP location difference for two examples of subsurface interface.

FIG. 14 is a flowchart listing method steps for optimizing 3D SRME for a target dataset that includes optimizing apertures and DRP spacing in an efficient/economical manner.

FIG. 15 is an area map showing apertures, DRPs, a source S and a receiver R, the map partitioned into blocks for use in an embodiment.

FIG. 16 is a flowchart listing method steps for alternative embodiment of optimizing 3D SRME for a target dataset.

FIG. 17 is an area map showing DRPs, source S, receiver R, contribution blocks and asymmetric apertures used in an embodiment.

FIG. 18 illustrates alias energy detection during decimation stacking for use in determining of optimal DRP spacing.

FIGS. 19A and 19B are a flowchart focusing on the method steps for determining optimal aperture and DRP spacing for an embodiment.

### DETAILED DESCRIPTION

Reference will now be made in detail to embodiments, examples of which are illustrated in the accompanying drawings and FIGS. (FIGS.). In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the invention herein is for the purpose of describing particular embodiments and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes”, “including”, “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting” depending on the context.

Those with skill in the art will appreciate that while some terms in this disclosure may refer to absolutes, e.g., all of the components of a wavefield, all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute is used, the disclosure may also be interpreted to be referring to a subset.

### Computing Systems

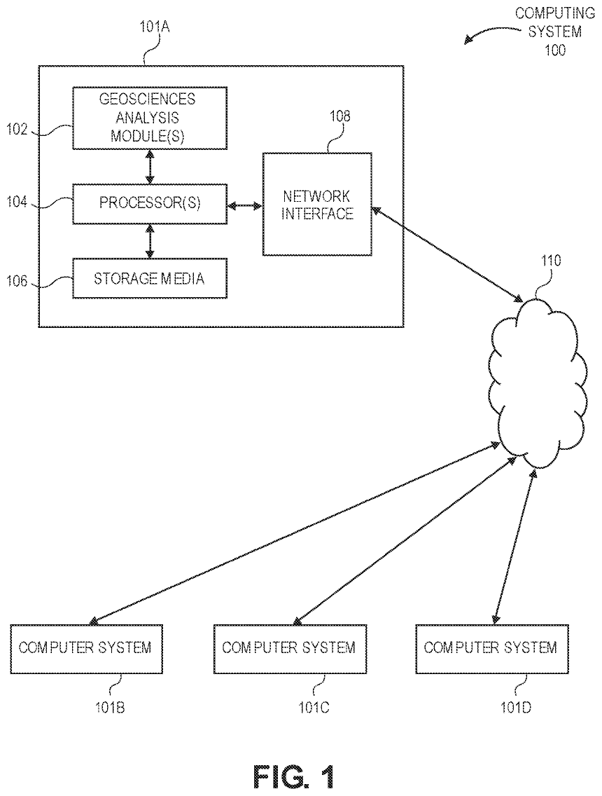

FIG. 1 depicts an example computing system 100 in accordance with some embodiments. The computing system 100 can be an individual computer system 101A or an arrangement of distributed computer systems. The computer system 101A includes one or more geosciences analysis modules 102 that are configured to perform various tasks according to some embodiments, such as one or more methods disclosed herein. To perform these various tasks, the geosciences analysis module 102 executes independently, or in coordination with, one or more processors 104, which is (or are) connected to one or more storage media 106. The processor(s) 104 is (or are) also connected to a network interface 108 to allow the computer system 101A to communicate over a data network 110 with one or more additional computer systems and/or computing systems, such as 101B, 101C, and/or 101D (note that computer systems 101B, 101C and/or 101D may or may not share the same architecture as computer system 101A, and may be located in different physical locations, e.g., computer systems 101A and 101B may be on a ship underway on the ocean, while in communication with one or more computer systems such as 101C and/or 101D that are located in one or more data centers on shore, other ships, and/or located in varying countries on different continents). Note that data network 110 may be a private network, it may use portions of public networks, it may include remote storage and/or applications processing capabilities (e.g., cloud computing).

A processor can include a microprocessor, microcontroller, processor module or subsystem, programmable integrated circuit, programmable gate array, or another control or computing device.

The storage media 106 can be implemented as one or more computer-readable or machine-readable storage media. Note that, while in the example embodiment of FIG. 1, storage media 106 is depicted as within computer system 101A, in some embodiments, storage media 106 may be distributed within and/or across multiple internal and/or external enclosures of computing system 101A and/or additional computing systems. Storage media 106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. Note that the instructions discussed above can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computer system 101A is one example of a computing system, and that computer system 101A may have more or fewer components than shown, may combine additional components not depicted in the example embodiment of FIG. 1, and/or computer system 101A may have a different configuration or arrangement of the components depicted in FIG. 1. The various components shown in FIG. 1 may be implemented in hardware, software, or a combination of both, hardware and software, including one or more signal processing and/or application specific integrated circuits.

It should also be appreciated that while no user input/output peripherals are illustrated with respect to computer systems 101A, 101B, 101C, and 101D, many embodiments of computing system 100 include computer systems with keyboards, mice, touch screens, displays, etc. Some computer systems in use in computing system 100 may be desktop workstations, laptops, tablet computers, smartphones, server computers, etc.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of protection.

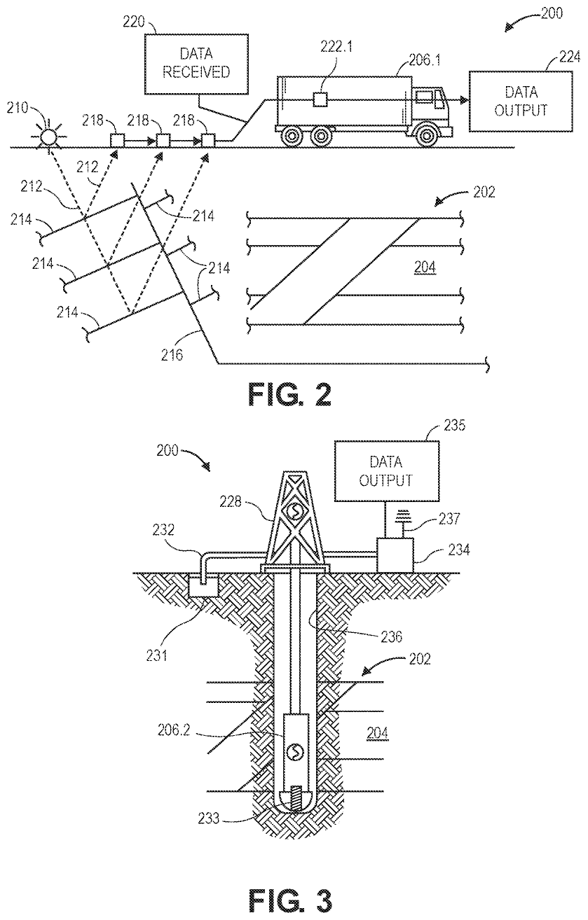

FIGS. 2-5 illustrate simplified, schematic views of an oilfield having a subterranean formation containing a reservoir therein in accordance with implementations of various technologies and techniques described herein. More particularly, FIG. 2 illustrates a survey operation being performed by a survey tool, such as seismic truck 206.1, to measure properties of the subterranean formation. The survey operation is a seismic survey operation for producing sound vibrations. In FIG. 2, one such sound vibration (e.g., sound vibration 212 generated by source 210) reflects off horizons 214 in earth formation 216. A set of sound vibrations is received by sensors, such as geophone-receivers 218, situated on the earth's surface. The data received 220 is provided as input data to a computer 222.1 of a seismic truck 206.1, and responsive to the input data, the computer 222.1 generates seismic data output 224. This seismic data output may be stored, transmitted or further processed as desired, for example, by data reduction.

FIG. 3 illustrates a drilling operation being performed by drilling tools 206.2 suspended by rig 228 and advanced into a subterranean formations 202 to form a wellbore 236. A mud pit 230 is used to draw drilling mud into the drilling tools via flow line 232 for circulating drilling mud down through the drilling tools, then up wellbore 236 and back to the surface. The drilling mud is typically filtered and returned to the mud pit. A circulating system may be used for storing, controlling, or filtering the flowing drilling mud. The drilling tools are advanced into the subterranean formations 202 to reach the reservoir 204. Each well may target one or more reservoirs. The drilling tools are adapted for measuring downhole properties using logging while drilling tools. The logging while drilling tools may also be adapted for taking core sample 233 as shown.

Computer facilities may be positioned at various locations about the oilfield 200 (e.g., the surface unit 234) and/or at remote locations. The surface unit 234 may be used to communicate with the drilling tools and/or offsite operations, as well as with other surface or downhole sensors. The surface unit 234 is capable of communicating with the drilling tools to send commands to the drilling tools, and to receive data therefrom. The surface unit 234 may also collect data generated during the drilling operation and produce data output 235, which may then be stored or transmitted.

Sensors(S), such as gauges, may be positioned about the oilfield 200 to collect data relating to various oilfield operations as described previously. As shown, the sensor(S) is positioned in one or more locations in the drilling tools and/or at the rig 228 to measure drilling parameters, such as weight on bit, torque on bit, pressures, temperatures, flow rates, compositions, rotary speed, and/or other parameters of the field operation. The sensors(S) may also be positioned in one or more locations in the circulating system.

Drilling tools 206.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 234. The bottom hole assembly further includes drill collars for performing various other measurement functions.

The bottom hole assembly may include a communication subassembly that communicates with surface unit 234. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

The wellbore may be drilled according to a drilling plan that is established prior to drilling. The drilling plan sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected.

The data gathered by the sensors(S) may be collected by the surface unit 234 and/or other data collection sources for analysis or other processing. The data collected by the sensors(S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

The surface unit 234 may include a transceiver 237 to allow communications between the surface unit 334 and various portions of the oilfield 200 or other locations. The surface unit 234 may also be provided with or functionally connected to one or more controllers (not shown) for actuating mechanisms at the oilfield 200. The surface unit 234 may then send command signals to the oilfield 200 in response to data received. The surface unit 234 may receive commands via the transceiver 237 or may itself execute commands to the controller. A processor may be provided to analyze the data (locally or remotely), make the decisions and/or actuate the controller. In this manner, the oilfield 200 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

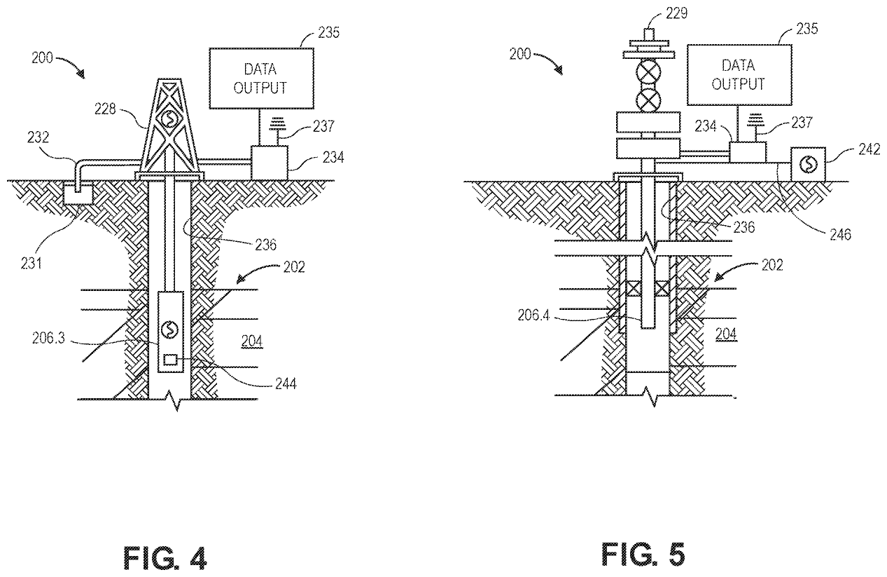

FIG. 4 illustrates a wireline operation being performed by a wireline tool 206.3 suspended by the rig 228 and into the wellbore 236 of FIG. 3. The wireline tool 206.3 is adapted for deployment into the wellbore 236 for generating well logs, performing downhole tests and/or collecting samples. The wireline tool 206.3 may be used to provide another method and apparatus for performing a seismic survey operation. The wireline tool 206.3 may, for example, have an explosive, radioactive, electrical, or acoustic energy source 244 that sends and/or receives electrical signals to surrounding subterranean formations 202 and fluids therein.

The wireline tool 206.3 may be operatively connected to, for example, geophones 218 and a computer 222.1 of a seismic truck 206.1 of FIG. 2. The wireline tool 206.3 may also provide data to the surface unit 234. The surface unit 234 may collect data generated during the wireline operation and may produce data output 235 that may be stored or transmitted. The wireline tool 106.3 may be positioned at various depths in the wellbore 236 to provide a survey or other information relating to the subterranean formation 202.

The sensors (S), such as gauges, may be positioned about the oilfield 200 to collect data relating to various field operations as described previously. As shown, the sensor S is positioned in the wireline tool 206.3 to measure downhole parameters which relate to, for example porosity, permeability, fluid composition and/or other parameters of the field operation.

FIG. 5 illustrates a production operation being performed by a production tool 206.4 deployed from a production unit or a Christmas tree 229 and into the completed wellbore 236 for drawing fluid from the downhole reservoirs into surface facilities 242. The fluid flows from the reservoir 204 through perforations in the casing (not shown) and into the production tool 206.4 in the wellbore 236 and to the surface facilities 242 via a gathering network 246.

The sensors (S), such as gauges, may be positioned about the oilfield 200 to collect data relating to various field operations as described previously. As shown, the sensor (S) may be positioned in the production tool 206.4 or associated equipment, such as the Christmas tree 229, the gathering network 246, the surface facility 242, and/or the production facility, to measure fluid parameters, such as fluid composition, flow rates, pressures, temperatures, and/or other parameters of the production operation. Production may also include injection wells for added recovery. One or more gathering facilities may be operatively connected to one or more of the wellsites for selectively collecting downhole fluids from the wellsite(s).

While FIGS. 3-5 illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 2-5 are intended to provide a brief description of an example of a field usable with oilfield application frameworks. Part of, or the entirety of, the oilfield 200 may be on land, water, and/or sea. Also, while a single field measured at a single location is depicted, oilfield applications may be utilized with any combination of one or more oilfields, one or more processing facilities and one or more wellsites.

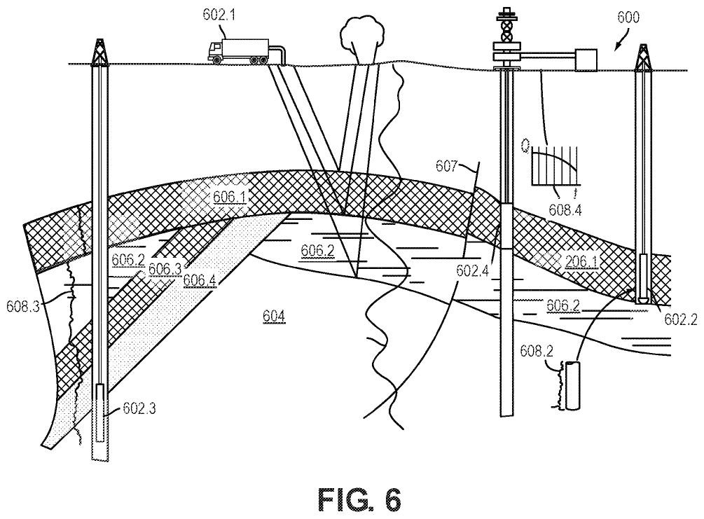

FIG. 6 illustrates a schematic view, partially in cross section of an oilfield 600 having data acquisition tools 602.1, 602.2, 602.3 and 602.4 positioned at various locations along the oilfield 600 for collecting data of the subterranean formation 604 in accordance with implementations of various technologies and techniques described herein. The data acquisition tools 602.1-602.4 may be the same as the data acquisition tools 206.1-206.4 of FIGS. 2-5, respectively, or others not depicted. As shown, the data acquisition tools 602.1-602.4 generate data plots or measurements 608.1-608.4, respectively. These data plots are depicted along the oilfield 600 to demonstrate the data generated by the various operations.

The data plots 608.1-608.3 are examples of static data plots that may be generated by the data acquisition tools 602.1-602.3, respectively; however, it should be understood that the data plots 608.1-608.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

The static data plot 608.1 is a seismic two-way response over a period of time. The static plot 608.2 is core sample data measured from a core sample of the formation 604. The core sample may be used to provide data, such as a graph of the density, porosity, permeability, or some other physical property of the core sample over the length of the core. Tests for density and viscosity may be performed on the fluids in the core at varying pressures and temperatures. The static data plot 608.3 is a logging trace that provides a resistivity or other measurement of the formation at various depths.

A production decline curve or graph 608.4 is a dynamic data plot of the fluid flow rate over time. The production decline curve provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 604 has a plurality of geological formations 606.1-606.4. As shown, this structure has several formations or layers, including a shale layer 606.1, a carbonate layer 606.2, a shale layer 606.3 and a sand layer 606.4. A fault 607 extends through the shale layer 206.1 and the carbonate layer 606.2. The static data acquisition tools are adapted to take measurements and detect characteristics of the formations.

While a specific subterranean formation with specific geological structures is depicted, it will be appreciated that the oilfield 600 may contain a variety of geological structures and/or formations, sometimes having extreme complexity. In some locations (e.g., below the water line) fluid may occupy pore spaces of the formations. Each of the measurement devices may be used to measure properties of the formations and/or its geological features. While each acquisition tool is shown as being in specific locations in the oilfield 600, it will be appreciated that one or more types of measurement may be taken at one or more locations across one or more fields or other locations for comparison and/or analysis.

The data collected from various sources, such as the data acquisition tools of FIG. 6, may then be processed and/or evaluated. Seismic data displayed in the static data plot 608.1 from the data acquisition tool 602.1 is used by a geophysicist to determine characteristics of the subterranean formations and features. The core data shown in the static plot 608.2 and/or log data from the well log 608.3 are used by a geologist to determine various characteristics of the subterranean formation. The production data from the graph 608.4 is used by the reservoir engineer to determine fluid flow reservoir characteristics. The data analyzed by the geologist, geophysicist and the reservoir engineer may be analyzed using modeling techniques.

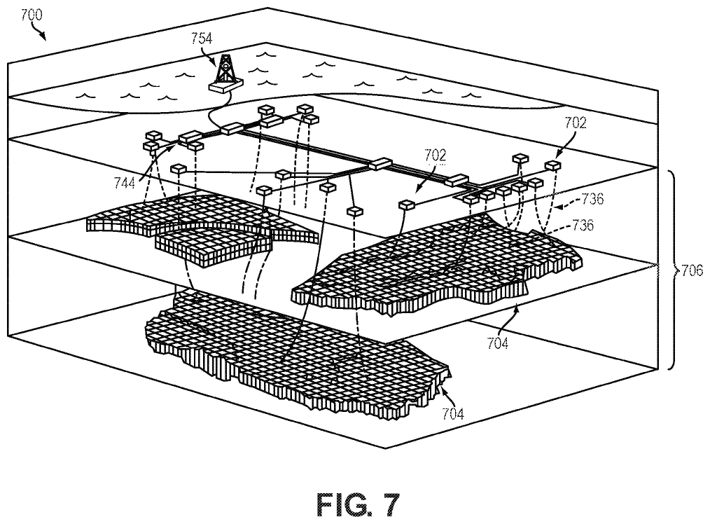

FIG. 7 illustrates an oilfield 700 for performing production operations in accordance with implementations of various technologies and techniques described herein. As shown, the oilfield has a plurality of wellsites 702 operatively connected to a central processing facility 754. The oilfield configuration of FIG. 7 is not intended to limit the scope of the oilfield application system. At least some of the oilfield may be on land and/or sea. Also, while a single oilfield with a single processing facility and a plurality of wellsites is depicted, any combination of one or more oilfields, one or more processing facilities and one or more wellsites may be present.

Each wellsite 702 has equipment that forms a wellbore 736 into the earth. The wellbores extend through subterranean formations 706 including reservoirs 704. These reservoirs 704 contain fluids, such as hydrocarbons. The wellsites draw fluid from the reservoirs and pass them to the processing facilities via surface networks 744. The surface networks 744 have tubing and control mechanisms for controlling the flow of fluids from the wellsite to a processing facility 754.

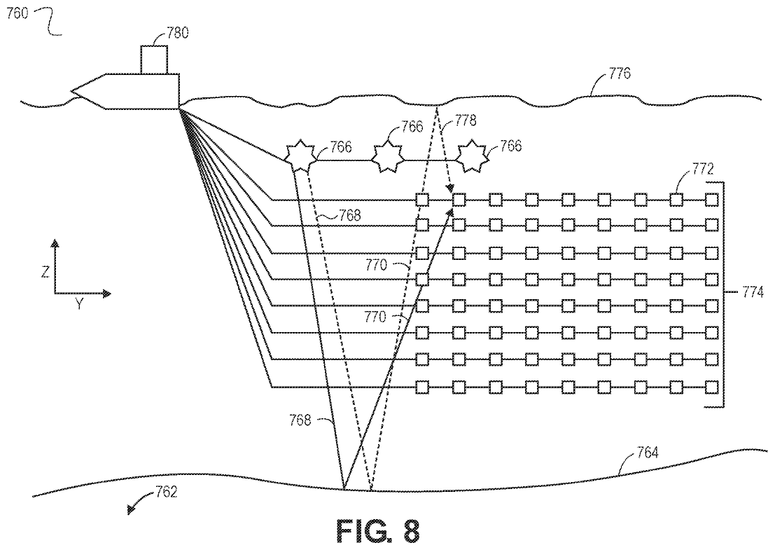

Attention is now directed to FIG. 8, which illustrates a side view of a marine-based survey 760 of a subterranean subsurface 762 in accordance with one or more implementations of various techniques described herein. The subsurface 762 includes a seafloor surface 764. Seismic sources 766 may include marine sources such as vibroseis or airguns, which may propagate seismic waves 768 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90Hz) over time.

The component(s) of the seismic waves 768 may be reflected and converted by the seafloor surface 764 (i.e., reflector), and seismic wave reflections 770 may be received by a plurality of seismic receivers 772. The seismic receivers 772 may be disposed on a plurality of streamers (i.e., streamer array 774). The seismic receivers 772 may generate electrical signals representative of the received seismic wave reflections 770. The electrical signals may be embedded with information regarding the subsurface 762 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, the seismic wave reflections 770 may travel upward and reach the water/air interface at the water surface 776, a portion of reflections 770 may then reflect downward again (i.e., sea-surface ghost waves 778) and be received by the plurality of seismic receivers 772. The sea-surface ghost waves 778 may be referred to as surface multiples. The point on the water surface 776 at which the wave is reflected downward is generally referred to as the downward reflection point.

The electrical signals may be transmitted to a vessel 780 via transmission cables, wireless communication or the like. The vessel 780 may then transmit the electrical signals to a data processing center. Alternatively, the vessel 780 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may include multiple reflectors, some of which may include dipping events, and may generate multiple reflections (including wave conversion) for receipt by the seismic receivers 772. In one implementation, the seismic data may be processed to generate a seismic image of the subsurface 762.

In one embodiment, marine seismic acquisition systems tow each streamer in streamer array 774 at the same depth (e.g., 5-10m). However, marine based survey 760 may tow each streamer in streamer array 774 at different depths such that seismic data may be acquired and processed in a manner that avoids the effects of destructive interference due to sea-surface ghost waves. For instance, the marine-based survey 760 of FIG. 8 illustrates eight streamers towed by vessel 780 at eight different depths. The depth of each streamer may be controlled and maintained using the birds disposed on each streamer.

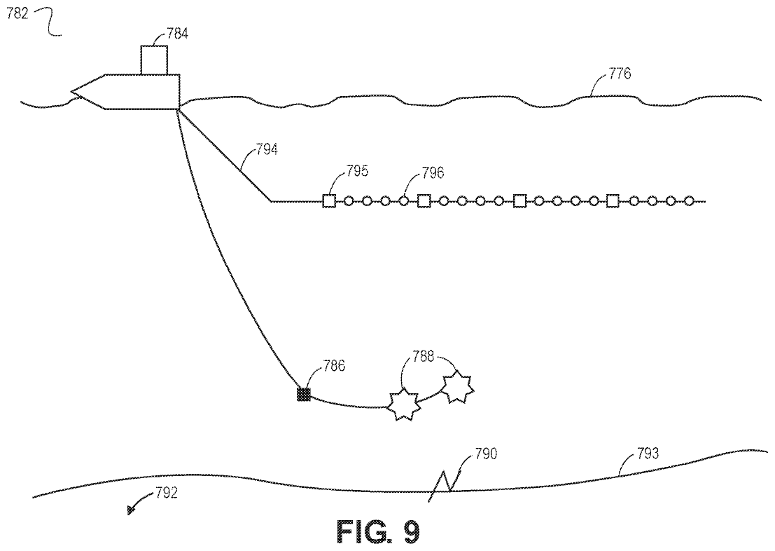

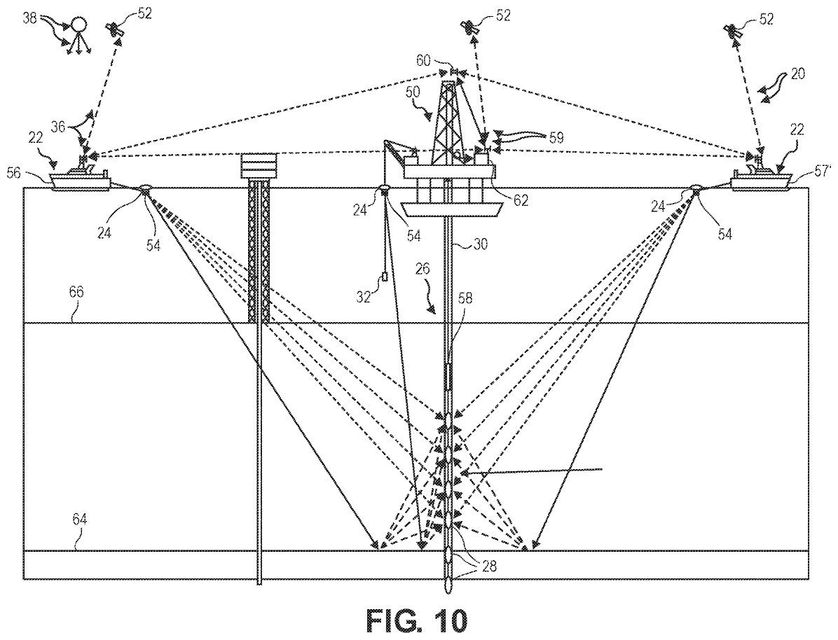

Attention is now directed to FIG. 9 that depicts a marine electromagnetic survey system 782 in accordance with implementations of various technologies described herein. The electromagnetic survey system 782 may use controlled-source electromagnetic (CSEM) survey techniques, but other electromagnetic survey techniques may also be used. Marine electromagnetic surveying may be performed by a survey vessel 784 that moves in a predetermined pattern along the surface 785 of a body of water such as a lake or the ocean. The survey vessel 784 is configured to pull a towfish (e.g., an electric source) 786, which is connected to a pair of electrodes 788. During the survey, the vessel may stop and remain stationary for a period of time while obtaining measurements, while in some circumstances, the vessel may remain underway while obtaining measurements.

Attention is now directed to methods, techniques, and workflows for processing and/or transforming collected data that are in accordance with some embodiments. Some operations in the processing procedures, methods, techniques, and workflows disclosed herein may be combined and/or the order of some operations may be changed. Those with skill in the art will recognize that in the geosciences and/or other multi-dimensional data processing disciplines, various interpretations, sets of assumptions, and/or domain models such as velocity models, may be refined in an iterative fashion; this concept is applicable to the procedures, methods, techniques, and workflows as discussed herein. This iterative refinement can include use of feedback loops executed on an algorithmic basis, such as at a computing device (e.g., computing system 100, FIG. 1), and/or through manual control by a user who may make determinations regarding whether a given step, action, template, or model has become sufficiently accurate.

### Predicting Surface Related Multiples in Seismic Data

Turning now to seismic processing for multiple elimination, surface multiples are seismic events that have at least one downward reflection bounce from the surface, and they are coherent energy that would result in migration artefacts for most migration methods that utilize primary reflection events. So, common practices in seismic data processing industry are to first predict the free surface multiple model (construct a seismic trace consisting of the surface multiples) and then adaptively subtract such predicted multiple model traces from the original seismic data. The prediction of surface multiples is a very computationally intensive process. It is common for data processors to spend a few days to weeks in testing certain parameter values to achieve a good balance between the predicted multiple model quality and the computation cost.

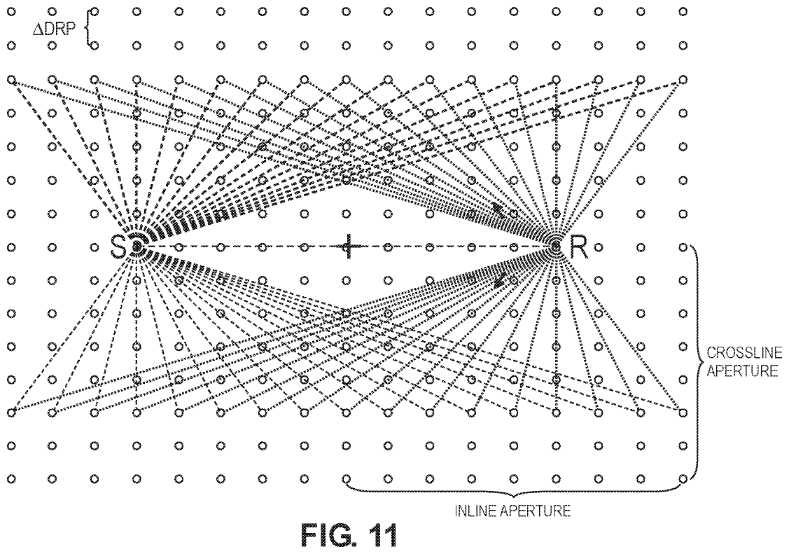

For the first step of constructing the free surface multiple model traces, 3D SRME is the most popular and proven effective method. 3D SRME, at the heart, is the integral over a specified surface area of the convolved trace pairs. In practice, the surface integral area consists of a regularly spaced downward reflection points (DRP) and the trace pairs are one from source to DRP and another from DRP to receiver (FIG. 11). The surface area has conventionally been defined as a rectangle centered at the midpoint of the source-receiver pair, and the distances from the midpoint to the rectangle edges are defined as apertures. Conceptually, this process can be viewed as consisting of two steps: the first step is the construction of a multiple contribution gather (MCG) for the target trace, i.e., to generate the convolved traces from the trace pairs on the DRP points within the surface aperture area with the total volume of convolved traces called multiple contribution gather. The second step is the summation or stacking of the multiple contribution gather traces and the stacked trace is the predicted surface multiple model trace for the target trace. To produce a high-quality multiple model using 3D SRME, large enough aperture that encloses the true DRPs (Downward Reflection Points) and fine DRP sampling that creates no alias stacking artefacts are used.

FIG. 11 illustrates a simplified representation of an area map used in the construction of the surface multiple model trace using 3D SRME. Each small circle of the regular grid in FIG. 11 is a downward reflection point (DRP). Multiple seismic traces are shown as trace pairs, each trace pair represented by one dashed line connecting the source S to a DRP and one dotted line connecting the same DRP to the receiver R. A convolved trace is computed at each DRP by the convolution of the trace pair, i.e., the dotted and dashed lines, at that DRP. A surface integral area encloses the DRPs is the surface aperture area and there are two apertures, the inline aperture is parallel to the line joining the source to receiver and the crossline aperture is perpendicular to the line joining the source and receiver.

The first step of constructing the multiple contribution gather is computationally very intensive because of the convolved trace data volume (typically more than 50,000 trace pairs) but also because of the operations that need to be performed before the convolution. The convolution at each DRP point involves two input seismic traces with strict location analysis: one is to have source at S and detector at the DRP and a second one to have source at DRP and receiver at R. The two traces are called desired traces. However, in reality it is rare that the two desired traces were actually acquired or exist in the input seismic data volume. More commonly, a nearest-neighbor search is performed to look for two available input seismic traces that are closest in a defined distance term to the two desired traces. This is followed by adjustment of events arrival times between the desired trace and the found trace. Both nearest-neighbor trace search and arrival time adjustment take computational resources and time as well.

Since a typical MCG consists of more than 50,000 convolved traces, more than 100,000 nearest-neighbor trace searches are performed, followed by arrival time adjustments and 50,000 convolutions for the computation of a single target trace. For this process, the surface aperture area (conventionally inline and crossline apertures) and DRP spacing directly determine the number of convolutions and, thus, the computational cost, choices of their values also directly impact the predicted surface multiple model quality. If the surface aperture area is not large enough, multiple events whose DRP lie outside the aperture area will not be predicted and will not be attenuated by the following adaptive subtraction. Thus, determining the optimal aperture area and DRP spacings are of relevance to 3D SRME.

In an MCG, there are two types of features that directly impact the choice of the parameter values: one type is apex area where the arrival times of seismic events in neighboring traces are almost flat and seismic events will stack coherently and produce true surface multiple events in the predicted multiple model trace. Another type of feature is the dipping or steeply dipping events which have no contribution to the predicted surface multiple models, and these seismic events tend to cancel each other during the stacking process. However, the steeply dipping events control the DRP spacing since stacking of these events with a too coarse DRP will produce alias stacking artefacts in the multiple model trace. Thus, an optimal or most cost-effective surface aperture should enclose the apex area and minimize the dipping area as much as possible. Reducing the dipping area eliminates the calculation for the area and also has the potential to loosen the DRP spacing and thus the total number of DRPs for the target trace.

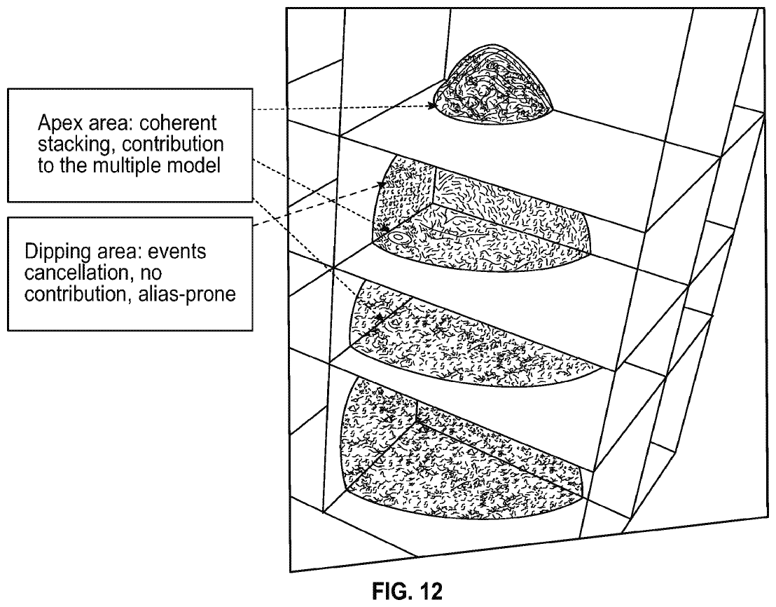

FIG. 12 illustrates two types of features in an MCG: apex area and dipping area. Apex areas are places where there are true downward reflections from the surface, the seismic events stack coherently and generate surface multiple events in the surface multiple model. The convolved traces in dipping areas tend to cancel each other during stacking/summation process and the resulted stack trace have amplitudes that are close to 0, which translates into the dipping areas having no or negligible contributions to the constructed surface multiple model trace. However, these areas use fine DRP spacing to avoid alias stacking. Improper DRP spacing for the dipping areas is prone to non-cancellation of seismic events and will result in high frequency oscillations or artefacts in the surface multiple model.

3D SRME will commonly use fixed offset-dependent inline aperture (or fixed extended aperture in addition to the half offset of the target trace), constant crossline aperture, and DRP samplings for the target traces of a seismic survey. However, it has been recognized that the apertures to predict high quality surface multiple models for seismic traces vary with the structural complexity of the subsurface, as well as the frequency-dependent Fresnel zone. For seismic traces sampling flat or mildly dipping subsurface geology, the inline and crossline apertures are small, while traces that sample complicated subsurface (faults, irregular shaped salt bodies, grabens) involve much larger inline and crossline apertures. Using fixed apertures without consideration of subsurface structures would either result in compromised result for some seismic traces or unnecessary computations for others.

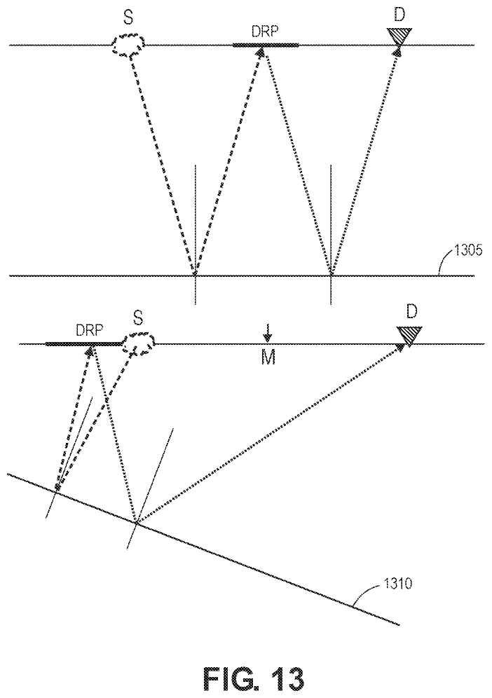

An example of varying aperture for seismic traces radiating through different subsurface structures is illustrated in FIG. 13. The top portion of FIG. 13 illustrates the true DRP for the first-order surface multiple for the flat interface 1305 is at the midpoint location and the aperture for the multiple is the frequency-dependent Fresnel zone, i.e., the true DRP is at the midpoint between source and receiver. The aperture for higher order multiples will be shifted either to the left or to the right side of the midpoint, but still lie inside the endpoints and is symmetric with regards to the midpoint. The bottom portion of FIG. 13 illustrates a single mildly dipping layer 1310. The true DRP for the first order surface multiple is outside of the end point on the up-dip direction, thus a much larger aperture, i.e., one that encloses the true DRP as well as the corresponding Fresnel zone, will be needed to predict the first-order surface multiple. The differences in apertures (distances from midpoint to the DRP) for these two simple cases illustrate the necessity of spatially varying apertures to run 3D SRME optimally and cost effectively. The spatially varying nature of the optimal apertures for different seismic traces and their dependency on subsurface-structure complexity result in cost effective 3D SRME being effectively unattainable without the assistance of a parameter determination tool.

Now turning to various embodiments of an automated cost-effective workflow to run three-dimensional surface related multiple elimination (3D SRME) seismic data processing method in production. The workflow integrates steps of automatic data-driven optimal parameter values determinations for parameters in 3D SRME for sparse representative target traces, population of the determined parameter values from the scattered sparse representative traces to the whole data volume, and final 3D SRME job run using the populated optimal parameters. The present disclosure may reduce users' testing time in production, but also ensure geophysical optimal or cost-effective aperture extents and DRP spacing for the predicted surface multiple model traces considering the available data volume of the acquired seismic data.

Embodiments of the present disclosure have enormous potential in helping allocate computational resources much more effectively, reducing users' testing time and projects' total turn-around time. As such, embodiments of this disclosure can improve the functioning of a computer system performing seismic processing. Various embodiments disclose workflows that automate and optimize the computationally intensive 3D SRME seismic data processing method for production. The method determines the most cost-effective values for the parameters in 3D SRME for given seismic data volume with little user intervention.

3D SRME is a data-driven approach that predicts all orders of surface multiples and has been proved highly effective in predicting high quality surface multiple models. To produce high-quality surface multiple models for seismic surveys in geologically complex areas, the computation cost can be prohibitively expensive. To achieve a good balance between computation cost and model quality, it is common for data processors to spend a few days to weeks in extensive parameter testing in production.

Various embodiments disclose methods to estimate the most cost effective spatially varying parameter values for 3D SRME and a workflow to automate the process with little or no user intervention. Various embodiments help allocate computation resources effectively, and also reduce users' testing time for production to reach appropriate parameterization and gain confidence in the produced surface multiple model.

Some embodiments of the present disclosure integrate the data-driven automatic parameter determination method into an automated workflow for mass production jobs that involves little or no user intervention. In some instances, a method may include the improvement work of utilizing asymmetric apertures in MCG.

FIG. 13 illustrates a demonstration of DRP location difference for first-order surface multiple for one single subsurface interface. The DRP in the top illustration is at or close to the midpoint for a flat or nearly flat layer interface 1305 while, in the bottom illustration, the DRP is located outside of the endpoint in the updip direction for a mildly dipping layer 1310. Thus, while a symmetric aperture with respect to the midpoint is appropriate for simple flat or nearly flat interfaces such a symmetric aperture will result in unnecessarily high computation cost for dipping or complicated subsurface. The aperture for the mild dip case is generally large and is used in the up-dip direction or single sided. However, large apertures would be used for both sides if symmetric apertures were to be used as in conventional previous work.

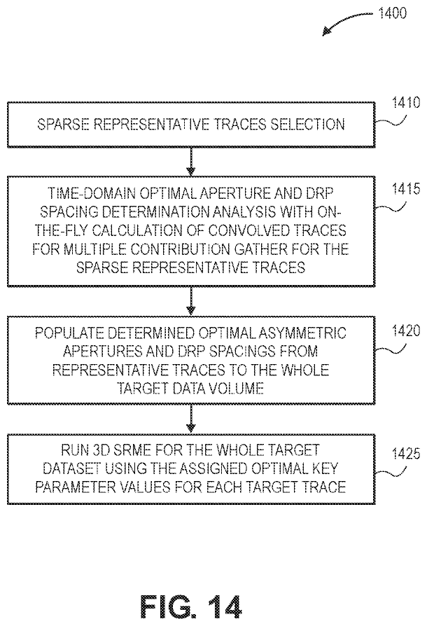

Optimal cost-effective apertures of 3D SRME for seismic traces vary depending on the complexity of subsurface structure through which the seismic waves of the different seismic traces radiate. Determination of the spatially varying optimal apertures is used to achieve a feasible amount of computation. Presented herein are various embodiments that integrate the data-driven automatic determination of optimal apertures and DRP spacings into a cost-effective, automated, user-friendly workflow that makes 3D SRME production jobs run efficiently. The workflow is generally illustrated in FIG. 14.

FIG. 14 presents a workflow 1400 for cost-effective 3D SRME. Selection 1410 is made of a subset of sparsely distributed representative target traces from the whole target data volume. The trace selection criteria can be pseudo-random or a regular decimation of the target data volume. Regular decimation of the target data volume can be easily achieved for marine streamer data, for example, selecting every 5th shot, 30-40th receiver etc. Existing information about the seismic survey could be optionally integrated into the trace selection, for example, earth models from previous surveys or acquisition geometry etc., areas where local subsurface geology is simple and varies slowly, trace selection can be sparser.

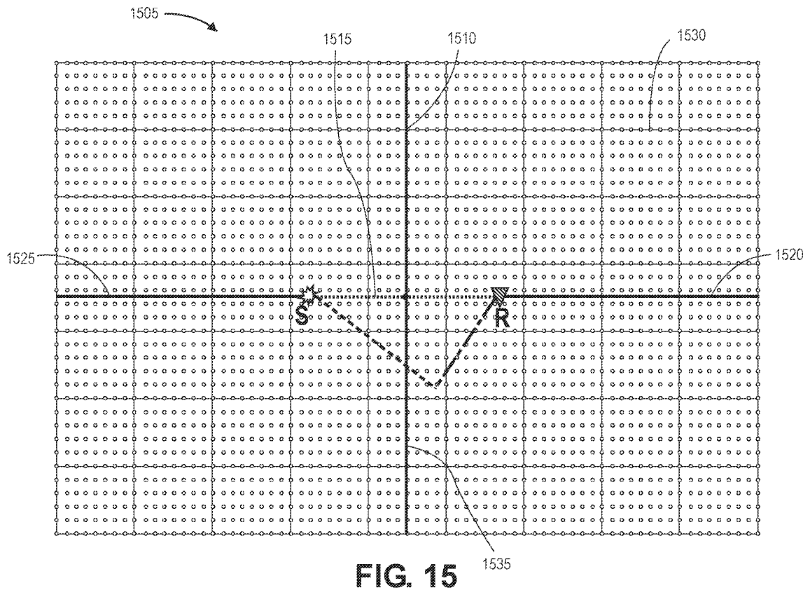

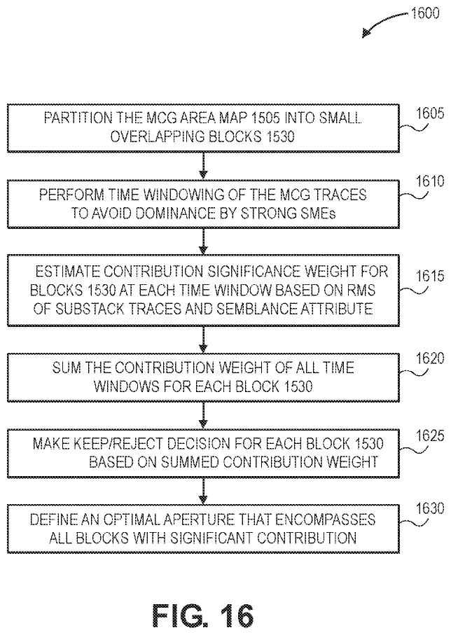

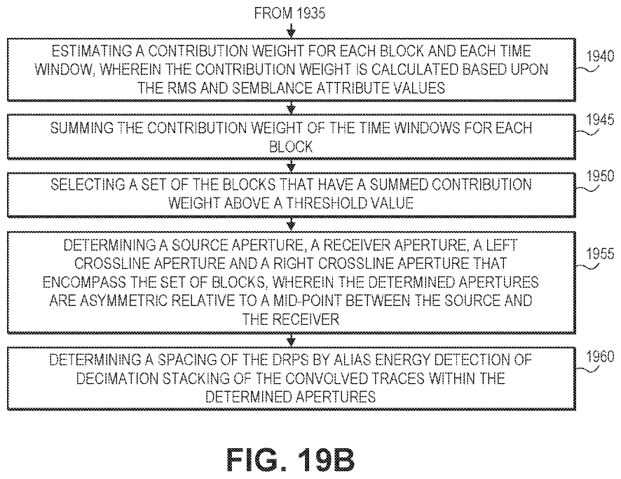

Determination 1415 is made of optimal apertures and DRP spacings for the representative target traces based on the proposed contribution analysis for apertures and alias energy detection in decimation stacking. Expanded details regarding an embodiment of determination 1415 is illustrated at FIG. 19 and described hereinbelow. Conceptually, it is assumed that MCGs for the sparse representative traces have been created using large apertures and fine DRP spacing. An area map 1505 of MCG and DRPs is shown in FIG. 15. The determination process 1415 seeks optimal asymmetric apertures, discussed further hereinbelow, and begins with partition of the area map 1505 into small overlapping blocks. In this example, the MCG area map 1505 is partitioned into nine inline blocks and seven crossline blocks. For the sake of simplicity, the blocks 1530 in FIG. 15 are not shown as overlapping. In practice, blocks 1530 may overlap and traces in the overlap area may be tapered before the analysis.

FIG. 15 shows fifty-four blocks 1530 arranged in an array of nine blocks 1530 across by seven blocks 1530 down. Point “S” in FIG. 15 is the source and point “R” is the receiver. Each open circle is a DRP. Several apertures are depicted in FIG. 15. A left crossline aperture 1510 extends perpendicularly from the line joining the source and receiver (“the S-R line 1515”) to the edge of the area map 1505. A right crossline aperture 1535 extends perpendicularly from the line joining the source and receiver (“the S-R line 1515”) to the edge of the area map 1505. A receiver aperture 1520 is parallel to the S-R line 1515 and extends from the receiver point R to the edge of the map 1505 closest to R. A source aperture 1525 is parallel to the S-R line 1515 and extends from the source point S to the edge of the map 1505 closest to S. The four apertures shown in FIG. 15 encompass the entire area map 1505 and, thus, are not optimized.

Optimal asymmetric apertures are determined in a multi-step process applied to area map 1505 being partitioned into overlapping blocks 1530. The total stack of the convolved trace pairs of the MCG will produce the multiple models for a target trace. The optimal asymmetric aperture and DRP spacing process 1900 is illustrated at FIG. 19. The full seismic data set is received 1905 as target traces and is sparse sampled 1920 to produce a representative subset of target traces. A broad area map 1505 is generated 1915 for each representative target trace. The broad area map 1505 included multiple DRP points laid out as a grid and multiple blocks 1530, wherein each block 1530 makes up a portion of the broad area map 1505. Source S and Receiver R locations may be referenced to the broad area map 1505.

Process 1900 convolves a seismic trace pair 1920 for each DRP to produce a convolved trace. The seismic trace pair may include more than one seismic sample value and the convolved trace may include more than one convolved sample value. Optionally, time windowing of the convolved traces may be performed to avoid dominance by strong multiple events. The convolved trace is assigned 1925 to one of the blocks 1530 and the convolved trace may be divided 1930 into a plurality of time windows. A root mean square (RMS) and a semblance attribute are calculated 1935 for the convolved trace for each block at each time window. The RMS of the substack traces is directly proportional to RMS of stack model trace. The semblance attribute is given by the formula

$$\frac{{\sum }_{i = 1}^{N} {( {\sum }_{j = 1}^{M} {d}_{ij} )}^{2}}{M {\sum }_{i = 1}^{N} {\sum }_{j = 1}^{M} {d}_{ij}^{2}}$$

for coherency analysis. In this formula, dᵢⱼ is the seismic sample value at time tᵢ and location xⱼ, M is the number of traces within the block 1530 and N is the total number of time samples within the time window. A contribution weight for each block at each time window is calculated or estimated 1940 based on RMS of the substack traces and the semblance attribute of the convolved sample values of the convolved traces. The contribution weight of the time windows for each block 1530 is summed 1945 and a selection is made 1950 of each block 1530 based on contribution weight and those with a value above a threshold value are determined to be contribution blocks 1732. A rectangular portion of the broad area map 1505 that covers the contribution blocks 1732 is defined as an optimal aperture rectangle 1734. The optimal aperture rectangle 1734 may be asymmetric with regard to the S and R in the MCG area map 1505. The optimal aperture rectangle is used to determine the optimal apertures 1955. The optimal apertures may include a receiver aperture 1520, a source aperture 1525, a lift crossline aperture 1510 and a right crossline aperture 1535. Optimal spacing of the DRPs is determined 1960 by energy detection of decimation stacking of the convolved traces within the determined apertures.

The RMS energy of the substack traces is directly proportional to the amplitude or energy contribution of that block 1530 to the constructed multiple model trace, which is the summation of the substack traces from the blocks. The semblance attribute indicates the coherency of the seismic events, i.e., whether there are apexes in the time-spatial MCG sub-volume. Blocks 1530 with high RMS and high semblance have contribution to the multiple model while blocks with either low RMS or low semblance have a negligible contribution to the multiple model. The contribution weights of all the time windows are summed for each block 1530.

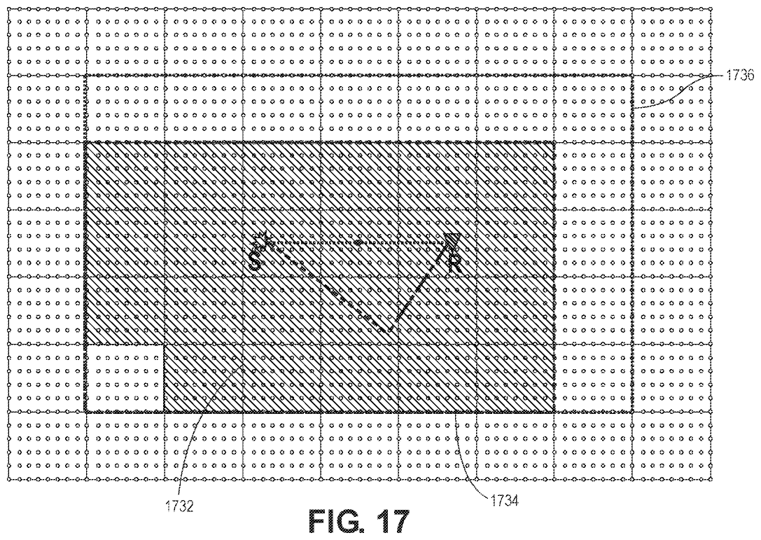

FIG. 17 illustrates a demonstration of the optimized aperture determination 1955 from the optimal asymmetric aperture and DRP spacing process 1900 of FIG. 19. The cross-hatched blocks are blocks determined to have contributions to the multiple model, i.e., contribution blocks 1732. An optimal aperture rectangle 1734 is the minimum sized rectangle encompassing every contribution block 1732. The optimal aperture rectangle 1734 will be the aperture area for the updated asymmetric aperture 3D SRME. Rectangle 1736 is symmetric with regard to S and R. The symmetric rectangle 1736 is the aperture area for conventional 3D SRME with symmetric apertures. In the example illustrated in FIG. 17, the aperture area is twenty-four blocks (6×4 blocks) for the asymmetric, optimal aperture 1734 and thirty-five blocks (7×5 blocks) for the symmetric aperture 1736. Thus, simply adopting the asymmetric apertures reduces the computation cost by about 30% ([(35−24)/35]×100)=31%).

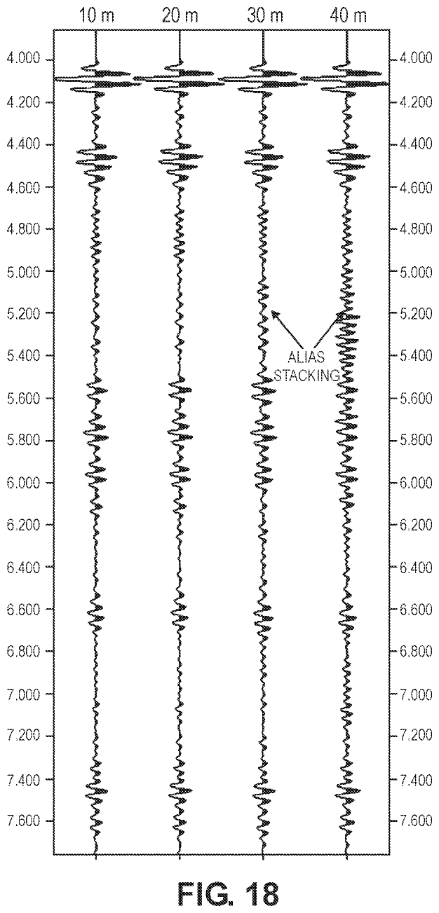

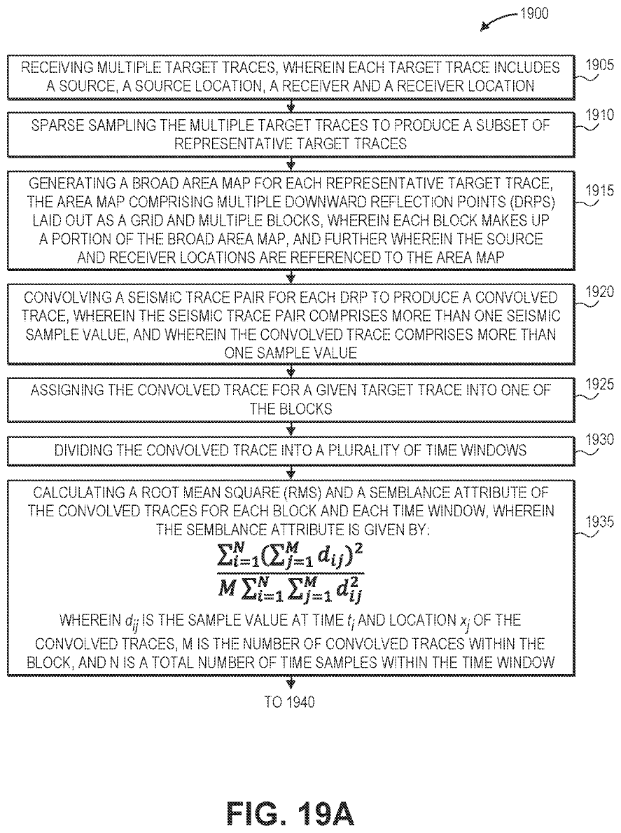

After the determination of optimal asymmetric apertures, optimal DRP spacing is determined 1960 by alias energy detection of decimation stacking of the time windowed convolved traces for the blocks inside the asymmetric aperture 1734. Desired optimal DRP spacing is as large as possible without introducing alias stack artefacts in the final multiple model trace. From sampling theory, occurrence of alias energy during stacking is frequency-dependent, and the higher the frequency, the finer the sampling is needed. The optimal DRP spacing is between the largest decimated DRP spacing where no or negligible alias energy is detected in the decimated stack trace and the smallest one where some amount of alias stack energy is detected in the decimated stack trace. Further refinement of the DRP spacing can be estimated by the spectral analysis of the decimated substack traces with alias stacking artefacts based on the linear relationship between the occurrence frequency of the aliased energy and the sampling. Decimation stacking and optimal DRP spacing determination is illustrated in FIG. 18.

FIG. 18 shows decimation stacking for optimal DRP spacing determination 1960. The trace 1802 is for DRP spacing of 10 meters. A trace for 20 meters DRP spacing 1804, 30 meters DRP spacing 1806 and 40 meters DRP spacing 1808 are also shown. Another way to look at these signals is that the 10 m signal 1802 sums all the convolved traces, while the DRP spacing of 20 m 1804 has a decimation factor of 2, i.e., every second trace along both inline and crossline axes is summed up. Decimation by a factor of 3, e.g., the 30 m signal 1806, sums up every third DRP and decimation by a factor of 4, e.g., 40 m signal 1808, sums every fourth DRP. In FIG. 18, trace 1804 having a DRP spacing of 20 has negligible aliased energy and it is the largest acceptable DRP spacing without stacking artefacts. That is, the alias artefacts for trace 1806 and trace 1808 are too high and, thus, both 30 m and 40 m DRP spacings are excessive. Optimal DRP spacing is thus determined to be 20 meters.

After the determination of the optimal cost-effective asymmetric apertures and DRP spacings for the sparse representative traces 1415, the values will be populated from the scattered sparsely sampled traces to the whole target data volume by high-dimensional interpolations with optional smoothing, 1420 in FIG. 14. For this parameter population step 1420, various data population techniques could be adopted and consideration factors for data population include distances of the target traces to the sparse representative traces, complexity of geology and variation patterns of local geology, etc. After the parameter value population step 1420, the most cost-effective aperture values and DRP spacings are assigned to the target traces in the full target data volume.

The final step for the FIG. 14 workflow is to run 3D SRME with the whole target data volume using the assigned optimal cost-effective apertures and DRP samplings 1425. After running the 3D SRME, the results may be utilized in any manner in which such results are used in the industry. For example, the 3D SRME results may be reviewed in order to take actions like selecting an optimal location to drill a wellbore, varying the trajectory of a new wellbore or selecting drilling parameters such as the weight or torque applied to a drill bit during drilling operations.

### Observations

Some embodiments described here include an automated cost-effective 3D SRME workflow for production. In production, data processors frequently face the challenge of producing good multiple models within budget limitations. To solve the challenge, processors frequently make decisions based on limited testing of selected subsurface lines, which are rarely the optimal solution for the full data volume.

The proposed automated workflow first selects a small subset of representative target traces from each sub-surface line, followed by data-driven optimal cost-effective parameter values determination for these sparse representative traces, and then the optimal values can be populated to the whole subsurface line. The final 3D SRME would be very cost-effective, and the introduction of asymmetric apertures had enormous potential in reducing the computation cost.

Turning to an example set of embodiments, in one implementation, a method to automatically determine cost-effective parameterizations for seismic data processing technology is provided. It begins with selecting or marking a small subset of representative target traces from a seismic data volume based on sparse sampling; one then runs processing technology on the marked or selected subset using a wide range of values for one or more parameters to generate results; evaluating the generated results with different sets of parameters and applying a criterion to evaluate how effective each set of parameters is in terms of quality and cost; selecting the set of parameters associated with the most cost-effective solution for the subset of data based on the chosen criteria; interpolating the selected set of parameter values from the representative subset data to the whole data volume, which in some instances is performed by using numerical methods; and running the seismic data processing technology for the whole data volume using the so determined parameters.

In some embodiments, the seismic processing technology aims to construct the free surface multiple model trace; in various instances, the processing may be data driven 3D SRME. In some embodiments, an intermediate result for a single run of the processing technology with the most comprehensive parameterizations is created, from which results with the interested range of parameters could be derived. In some embodiments, the method further comprises dividing the seismic traces into smaller time windows to balance amplitude differences of seismic events at different times and minimize analysis dominance by high amplitude events. In some embodiments, the parameters to select are asymmetric apertures and DRP spacing And the method may further comprise partitioning a possible aperture into overlapping blocks, and application of contribution analysis of the blocks based on the energy level (RMS value) of the substack traces and semblance value of the sub volumed data for each time window or one or more time windows. In some embodiments, the method may further comprise determining the effective DRP spacing based on alias stacking energy detection and spectral analysis of the substack traces with different decimation factors. In some embodiments, the method may further comprise determining the final aperture area based on the summed contribution weights over time windows for each block, and the shape of the final aperture area could be a convex polygon of any shape. In further embodiments, the polygon is a rectangle in widespread practice and could be located anywhere regarding the seismic trace, i.e., it does not need to be centered at the midpoint.

In some embodiments, the interpolation of selected parameter values could be based on nearest neighbor, spline, sinc or compressive sensing. In some embodiments, considerations for selection criteria may consider computation cost, quality, or both.

The steps in the processing methods described above may be implemented by running one or more functional modules in information processing apparatus such as general- purpose processors or application specific chips, such as ASICs, FPGAs, PLDs, or other appropriate devices. These modules, combinations of these modules, and/or their combination with general hardware are included within the scope of protection.

Of course, many processing techniques for collected data, including one or more of the techniques and methods disclosed herein, may also be used successfully with collected data types other than seismic data. While certain implementations have been disclosed in the context of seismic data collection and processing, those with skill in the art will recognize that one or more of the methods, techniques, and computing systems disclosed herein can be applied in many fields and contexts where data involving structures arrayed in a multi-dimensional space and/or subsurface region of interest may be collected and processed, e.g., medical imaging techniques such as tomography, ultrasound, MRI and the like for human tissue; radar, sonar, and LIDAR imaging techniques; mining area surveying and monitoring, oceanographic surveying and monitoring, and other appropriate multi-dimensional imaging problems.

Many examples of equations and mathematical expressions have been provided in this disclosure. But those with skill in the art will appreciate that variations of these expressions and equations, alternative forms of these expressions and equations, and related expressions and equations that can be derived from the example equations and expressions provided herein may also be successfully used to perform the methods, techniques, and workflows related to the embodiments disclosed herein.

Those with skill in the art will appreciate that in some embodiments, use of terms such as ‘optimal’ or ‘optimize’ may mean ‘best’ or most conducive to a favorable outcome, e.g. maximizing or minimizing something; while in other circumstances, ‘optimal’ or ‘optimize’ may be to improve or increase or decrease or the like, depending on the context and solution.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to explain the principles of the invention and its practical applications, to thereby enable others skilled in the art to utilize the invention and various embodiments with various modifications as are suited to the particular use contemplated.

What is claimed is:

1. A method for determining optimized parameters for seismic data processing, the method comprising:
receiving a seismic data volume including target traces;
sparse sampling the target traces to produce a subset of representative target traces;
generating a broad area map for each representative target trace, the area map including multiple downward reflection points (DRPs) laid out as a grid and multiple blocks, wherein each block makes up a portion of the broad area map;
convolving a seismic trace pair for each DRP to produce a convolved trace that includes more than one convolved sample value;
assigning the convolved trace into one or more of the blocks;
calculating a contribution weight based on a root mean square (RMS) and a semblance attribute for each block at each time window;
summing the contribution weights for all of the time windows for each block;
selecting a set of blocks that includes each block that has a summed contribution weight above a threshold value; and
determining one or more apertures that encompass the set of blocks.

2. The method of claim 1, comprising dividing the convolved trace into a plurality of time windows, wherein calculating the contribution weight includes estimating a contribution weight of each time window of each convolved trace in each block based upon the RMS and semblance attribute values, wherein the semblance attribute is given by:
$$\frac{{\sum }_{i = 1}^{N} {( {\sum }_{j = 1}^{M} {d}_{ij} )}^{2}}{M {\sum }_{i = 1}^{N} {\sum }_{j = 1}^{M} {d}_{ij}^{2}}$$
wherein dᵢⱼ is the convolved sample value at time tᵢ and location xⱼ of the convolved trace, M is the number of convolved traces within the block, and N is a total number of time samples within the time window.

3. The method of claim 1, comprising:
determining a spacing of the DRPs by alias energy detection of decimation stacking of the convolved traces within the determined apertures; and
performing seismic processing on the seismic data volume using the determined apertures and the determined DRP spacing, wherein the seismic processing includes data driven three-dimensional surface related multiple elimination (3D SRME) seismic processing, wherein the determined apertures are asymmetric relative to a mid-point between the source and the receiver.

4. The method of claim 3, comprising generating a migrated image based upon a result of the seismic processing.

5. The method of claim 1, wherein the apertures include a source aperture, a receiver aperture, a left crossline aperture, and a right crossline aperture.

6. The method of claim 5, including interpolating the determined apertures and the determined DRP spacing from the subset of the representative target traces onto the seismic data volume.

7. The method of claim 1, wherein each representative target trace includes a source, a source location, a receiver and a receiver location, and further wherein the area map is referenced to the source and receiver location.

8. The method of claim 1, wherein each of the multiple blocks overlaps with one or more adjacent blocks.

9. A computing system for determining optimized parameters for seismic data processing, the computing system comprising:
one or more processors; and
a memory system including one or more non-transitory computer-readable media storing instructions that, when executed by at least one of the one or more processors, cause the computing system to perform operations, the operations including:
receiving a seismic data volume including target traces;
sparse sampling the seismic data volume target traces to produce a subset of representative target traces;
generating a broad area map for each representative target trace, the area map including multiple downward reflection points (DRPs) laid out as a grid and multiple blocks, wherein each block makes up a portion of the broad area map;
convolving a seismic trace pair for each DRP to produce a convolved trace that includes more than one convolved sample value;
assigning the convolved trace into one or more of the blocks;
calculating a contribution weight for each block, wherein the contribution weight is calculated based upon a root mean square (RMS) value and a semblance attribute values;
selecting a set of the blocks that have a contribution weight above a threshold value;
determining one or more apertures that encompass the set of blocks, wherein the determined apertures are asymmetric relative to a mid-point between the source and the receiver; and
determining a spacing of the DRPs by alias energy detection of decimation stacking of the convolved traces within the determined apertures.

10. The computing system of claim 9, wherein the operations further include dividing the convolved trace into a plurality of time windows,
wherein calculating the contribution weight includes estimating a contribution weight of each time window of each convolved trace in each block based upon the RMS and semblance attribute values and summing the contribution weight of the time windows for each block, wherein the semblance attribute is given by:
$$\frac{{\sum }_{i = 1}^{N} {( {\sum }_{j = 1}^{M} {d}_{ij} )}^{2}}{M {\sum }_{i = 1}^{N} {\sum }_{j = 1}^{M} {d}_{ij}^{2}}$$
wherein dᵢⱼ is the convolved sample value at time tᵢ and location xⱼ of the convolved trace, M is the number of convolved traces within the block, and N is a total number of time samples within the time window.

11. The computing system of claim 9, wherein the operations further include performing seismic processing on the seismic data volume using the determined apertures and the determined DRP spacing, wherein the seismic processing includes data driven three- dimensional surface related multiple elimination (3D SRME) seismic processing.

12. The computing system of claim 9, wherein the operations further include:
generating a migrated image based upon a result of the seismic processing; and
performing an action based upon the migrated image.

13. The computing system of claim 9, wherein the apertures include a source aperture, a receiver aperture, a left crossline aperture and a right crossline aperture.

14. The computing system of claim 9, wherein the operations further include interpolating the determined apertures and the determined DRP spacing from the subset of the representative target traces onto the seismic data volume.

15. The computing system of claim 9, wherein each representative target trace includes a source, a source location, a receiver and a receiver location, and further wherein a broad area map is referenced to the source and receiver location.

16. The computing system of claim 9, wherein each of the multiple blocks overlaps with one or more adjacent blocks.

17. A non-transitory computer-readable medium storing instructions that, when executed by one or more processors of a computing system, cause the computing system to perform operations for determining optimized parameters for seismic data processing, the operations comprising:
receiving seismic volume data that includes target traces;
sparse sampling the target traces to produce a subset of representative target traces;
generating a broad area map for each representative target trace, the area map including multiple downward reflection points (DRPs) laid out as a grid and multiple blocks, wherein each block makes up a portion of the broad area map, and further wherein the area map is referenced to the source and receiver location;
convolving a seismic trace pair for each DRP to produce a convolved trace, wherein the seismic trace pair includes more than one seismic sample value, and wherein the convolved trace includes more than one convolved sample value;
assigning the convolved trace for a given target trace into one of the blocks;
dividing the convolved trace into a plurality of time windows;
calculating a root mean square (RMS) and a semblance attribute of the convolved traces for each block at each time window, wherein the semblance attribute is given by:
$$\frac{{\sum }_{i = 1}^{N} {( {\sum }_{j = 1}^{M} {d}_{ij} )}^{2}}{M {\sum }_{i = 1}^{N} {\sum }_{j = 1}^{M} {d}_{ij}^{2}}$$
wherein dᵢⱼ is the convolved sample value at time tᵢ and location xⱼ of the convolved traces, M is the number of convolved traces within the block, and N is a total number of time samples within the time window;
estimating a contribution weight for each block at each time window, wherein the contribution weight is calculated based upon the RMS and semblance attribute values;
summing the contribution weight of all of the time windows for each block;
selecting a set of the blocks that have a summed contribution weight above a threshold value;
determining a source aperture, a receiver aperture, a left crossline aperture and a right crossline aperture that encompass the set of blocks, wherein the determined apertures are asymmetric relative to a mid-point between the source location and the receiver location;
determining a spacing of the DRPs by alias energy detection of decimation stacking of the convolved traces within the determined apertures;
interpolating the determined apertures and the determined DRP spacing from the subset of the representative target traces onto the seismic volume data;
performing seismic processing on the seismic volume data using the determined apertures and the determined DRP spacing, wherein the seismic processing includes data driven three-dimensional surface related multiple elimination (3D SRME) seismic processing; and
generating a migrated image based upon a result of the 3D SRME.

18. The non-transitory computer-readable medium of claim 17, wherein the operations further include performing an action based upon the result of the 3D SRME seismic processing, wherein the action includes selecting where to drill a wellbore, determining or varying a trajectory of the wellbore, or a combination thereof.

19. The non-transitory computer-readable medium system of claim 17, wherein each of the multiple blocks overlaps with one or more adjacent blocks.

20. The non-transitory computer-readable medium system of claim 17, wherein each target trace includes a source, a source location, a receiver and a receiver location.
